(19) United States
(12) Patent Application Publication
(10) Pub. No.: US 2013/0090961 A1
(43) Pub. Date: Apr. 11, 2013

(54) System for a data supply chain to enable data suppliers to contribute data collection questions to data collection protocols and post data into said data collection protocols aligned with said data collection questions and compensate data suppliers and collect fees from data consumers and advertisers associated with the data supply chain.

(71) Applicant: Stanley Benjamin Smith, Fort Mill, SC (US)

(72) Inventor: Stanley Benjamin Smith, Fort Mill, SC (US)

(21) Appl. No.: 13/545,891

(22) Filed: Jul. 10, 2012

Related U.S. Application Data
(63) Continuation-in-part of application No. 13/271,157, filed on Oct. 11, 2011, now Pat. No. 8,271,346.

(51) Int. Cl. G06Q 10/00

(52) U.S. Cl. 705/7.11

(57) ABSTRACT

The present invention introduces a marketing platform for a data supply chain applying crowd-sourced, pervasive computing and social networking to data collection and distribution including exchange of fees for data suppliers who make contributions to data research protocols and subscriptions and other fees for data access and utilization by data consumers.

### BACKGROUND OF THE INVENTION

1. Field of the Invention

This invention relates to systems and methods for implementing a collection and distribution platform for data suppliers, data consumers, and advertisers to participate in crowd-sourced or swarm research or data gathering and distribution; and to exchange fees for contributions to said platform or for use of said platform.

2. Description of the Related Art

Social scientists have observed cases where efficiency in decision making and more effective choices among many alternative paths are exhibited by swarms of individual members of a species. Some scientists have begun to reframe the iterative improvement in scientific knowledge itself as a consequence of “swarm sourced” or “crowd-sourced” shared knowledge and judgment.

The continuing evolution of a pervasive computing environment has enabled the use of crowd sourcing and social networks to identify concatenating or repeating patterns that may enable researchers or any type of data consumer to leverage the capability of the “swarm.” Indeed, many of the recommendation utilities and programs available through the internet such as “Angie's List” function through organization and display of opinions from a “crowd” of consumers. Organized collection of observations or inputs into a data supply chain will increase the impact and potential for real-time pattern recognition and high data quality that is essential for testing hypotheses and determining courses of action resulting from iterative effective research. The improved potential to manage risks in medical service delivery and other crucial multi-dimensional networked information and knowledge management systems will offer great value to those with access to valid data in real time. Any definable networked resource or networked system can be used to capture change that can be noted through human observation and can be included or loaded through the system and method of the invention described herein. While the invention described herein introduces art for a particular method and system, it is expected that said method and system can be integrated wholly or in part with other research and business processes and methods.

A meta-frame for the invention is that it structures methods and systems to motivate or induce people to participate in socially networked crowd sourcing and pervasive computing for real time research. This invention expands the capacity to implement a knowledge economy across academic disciplines where the following features may be an advantage and improve the quality of research:
In-course changes and corrections to research data collection protocols or procedures.
In-course changes and corrections to items or questions embedded into research data collection protocols or procedures.
Implementation of selection criteria for inclusion, participation, and assignment of data suppliers.
Implementation of criteria for determining the value of a data contribution from a data supplier, such as its value or quality.
Use of crowd sourcing or pervasive computing capacities such as internet connections among distributed electronic devices, distributed databases, and distributed forms for collection of data.
Rating and vetting of data itself.
Collection of hyperlinks and images and other formats that might enrich qualitative and quantitative data if associated with said data.
Real-time transactions such as communication and calculation and payment or exchange of fees for subscriptions, contributions, placement of advertising banners for manufacturers and suppliers or service providers, or draw-downs of data or adjustments to data collection protocols or adjustments to questions associated with data collection protocols.

The invention described herein structures a system and method to enable data suppliers to design and construct data collection protocols, contribute data collection questions to said data collection protocols; post data into said data collection protocols aligned with said data collection questions; structure the collection of qualitative data as well as quantitative data; and associate or post other computer readable data strings with said data collection protocols and questions. Further, the invention described herein enables data consumers to access and purchase said data; for data suppliers to be compensated for design of said data collection protocols and for their contributions of questions to said data collection protocols; for data suppliers to be compensated for their contributions to datasets associated with said data collection protocols; for researchers or their surrogates to pay fees for inclusion of their qualitative or quantitative research questions or data collection protocols into a data supply chain; for knowledge publishers managers and distributors to assign values or prices or fees or weights to data collected through said data collection protocols for inclusion in articles or manuals or other products using the data collection and distribution platform of the invention described herein; for researchers who process qualitative as well as quantitative data to post said data into data visualization and processing tools and products; and for manufacturers, suppliers and providers of services associated with said data collection protocols to pay fees for sponsorship of research or placement of banners or other advertising upon computer screens associated with said data collection protocols and other outputs of the system and method of the invention described herein. Further, the system and method enables the data supplier or data consumer to retain a link to said data collection questions, said data collection protocols, and data entered in response to said data collection questions along with weights and values assigned to and associated with said data suppliers, data collection protocols, and data collection questions as a data consumer or repackager organizes, visualizes, constructs, and composes articles, reports, blog posts, presentations, training or teaching materials or manuals, and implements other uses of the data for knowledge management and knowledge distribution.

Art to implement data supply chains and provide incentives to participate in data supply has been evolving steadily since Smith introduced the term in his utility patent (U.S. Pat. No. 7,860,760). The invention described herein advances the advantages of the data supply chain with triggered real time notifications introduced by Smith (U.S. Pat. No. 7,860,760). That system and method, Smith (U.S. Pat. No. 7,860,760), enables pricing of notifications and server actions triggered by new or updated data streamed or posted into a data supply chain. Art introduced by Smith (Ser. No. 12/930,280) further enables pricing of a data item for inclusion into a data supply chain through a sequence of discovery of the data item through an internet search and then the calculation of its popularity or value as a search term. Smith (Ser. No. 12/932,798) also teaches art to weight and price contributions from variably weighted sources and variably weighted observations of research targets or data items. Additional art introduced by Smith (Ser. No. 12/932,797) describes a system and method for calculating fees for a participant in a data supply chain interacting with a graphical user interface (GUI) on a website or host server housing a dataset or a plurality of datasets accessible through said GUI. Further art introduced by Smith (Ser. No. 13/134,596) offers a system and method to facilitate and price data exchange through electronic devices linked to the systems and methods of Smith (U.S. Pat. No. 7,860,760, 146 Ser. No. 12/932,797, and 12/932,798). Art has also been described by Smith (Ser. No. 13/200,073) to integrate fees and rewards for incremental improvements, updates, and additions of data itself into data accumulation processes within Social Networks or networks of users and servers or websites. Smith (Ser. No. 13/136,421) further introduces a system and method for pricing insertion or linking of message streams, RFID tags, UPC codes, and other data strings (such as biometric or gene sequences) to data sources. That invention, Smith (Ser. No. 13/136,421), deals with pricing the uploading of data and data streams through electronic devices, rather than enrollment of participants into a data supply chain as Smith describes in (Ser. No. 13/271/157).

There is a long history of scientific research integrating use of a questionnaires or forms for structured data collection. The invention described herein advances existing systems and methods to adjust and improve data collection in process and vet and weight and compensate data suppliers for their contributions. Processes for data collection in the past focused upon database structure and posting into database tables. The focus of most applications for patents prior to 2006 submitted to the United States Patent Office was on how data was to be aggregated or federated. With the advent of pervasive computing and crowd sourcing that landscape has changed considerably, but most data centric systems and methods remain focused on data federation or aggregation. The vast majority of systems and methods relate to data processing, calculation, and visualization.

Siloed data within an enterprise used to be the rule, reducing the necessity for development of systems for compensation, allocation, or vetting for improved data collection formats; or development of methods to ease processes for data contributions in a distributed pervasive computing environment. The advantage of a pervasive computing environment is that it enables data to transcend single enterprises and become accessible to socially networked communities or crowds or swarms dispersed across organizations and individuals. Even in the recent past, few efforts have been made to develop the requisite systems and methods for research to leverage the new reality. Art introduced by Smith (Ser. No. 12/932,798) enables the weighting of input sources and the weighting of targets for observation and can be integrated with the art of Smith (U.S. Pat. No. 7,860,760) to improve relevance, timeliness and utility of data collected. Without social and monetary and other incentives to encourage participation, the volume of real time collection of observations from widely dispersed sets of data suppliers in real time is likely to be lower, resulting in slower accumulation of data that might trip a risk trigger or threshold. A simple process to improve and post research data collection protocols coupled with rewards and incentives and monetization of the process for posting and improving data collection protocols will facilitate a robust and continuous supply of actionable data. Additionally, providing access to portions of a data supply chain or actions generated through a data supply chain enables fees and payments to be charged to those who benefit from the data supplied or accessed. The highest and best use of the invention described herein is to enable continuous structured and vetted updated data to improve decision making regarding levels of risk, prioritizing allocation of resources, and other factors that can affect public health and safety and environmental sustainability.

The art involved in the invention described herein covers several areas such as; database access and design, pervasive and cloud computing, enrollment and registration of users of internet or database resources and tools; rating, weighting and scaling of data suppliers and their contributions to data research protocols; quantitative and qualitative data, and fees payments and rewards in consideration for contribution to or participation in or sponsoring of a research or data accumulation process. Definitions of the term “protocol” vary. For purposes of the invention disclosed herein, a “data collection protocol” is a structured organized format for collection of data that is subject to one or a plurality of constraints such as: type of data collected; requirements or standards for sources of data; preconditions or contexts for acceptance or inclusion of data; vetting procedures and rules for processing data; rigorous standards and requirements for input of the data including schedules and time or data ranges, data object formats, and other data or alphanumeric string formulation; and specific scoring, vetting, or verification rules. Prior art cited in the paragraphs that follow is therefore diverse and is introduced to shape understanding of the development of systems and methods to manage research data collection protocols that cross several disciplines and domains. Class 705 of the USPTO classification system and the art unit of 3625 are perhaps most applicable to the patent described herein, though other classes and art units may also apply. A secondary benefit for the review of prior art is to provide context for how embodiments of the invention described herein may be enriched and expanded in scope and quality through folding in art developed by the “crowd” for doing quality research. The inventor of the patent described herein has quoted freely from the abstracts and claims of the art described below in order to remain consistent with the frame of reference of the invention under discussion. The resulting terms, language, and phrasing may therefore seem to shift and the quotations may seem lengthy, but every effort has been made to be consistent with the terms of the invention described herein and to retain the integrity of the invention being cited.

Benson, (U.S. Pat. No. 8,150,857) introduces art for a “computer-implemented method and system” for assigning data input (and therefore data collection) to a “multi-contextual and multi-dimensional database.” Benson describes templates linked to domains or subject matter with associated “settings,” where said settings “comprise a default ontology or taxonomy, a reserved word or phrase list, and restricted value ranges, and where the template includes a template identification and a version.” Records or data in the database are generated based on the template or regenerated by inheriting attributes from existing data or records. This assignment of attributes results in a unique identification code which may carry a further attribute of a weight assigned to each record representing “a level of diligence used at a time of data entry, where the level of diligence is dependent in part on the default ontology or taxonomy and a reserved word or phrase list.” Benson shares a focus with the invention described herein concerning linking data collection to a domain and the term “template” may appear to imply a data collection protocol, but the system and method of the art actually describes a controlled or constricted inheritance of predefined features locked into a data structure or template that bypasses insertion or addition of new or unique questions to become part of a data collection protocol. The weighting described by Benson is based, not upon value, but upon diligence or accuracy in a manner quite distinct from that of the invention described herein.

Kahn, et al. (U.S. Pat. No. 7,444,293) offers a methodology to reduce risk of protocol ambiguities that could lead to operational failures in the conduct of clinical trials. Here, a user role he calls an “analyst” encodes the features of a protocol into a formally structured model created specifically to capture issues that may cause operational or quality difficulties in a clinical trial process. “The process forces the analyst to look for specific parameters in the text version of the protocol. The system creates a database of the protocol as encoded, and can display the protocol schema as a graphical network of protocol events and temporal links.” Kahn further offers a method to display these “descriptions of operational uncertainties.” Kahn's interpretation of the term “protocol” is directed to the operational sequences that are part of a clinical study and the display of potential ambiguities or problems within said sequences, and actually has little or no relationship to what is meant in the invention described herein as a “data collection protocol.” The reason for including Kahn in the description of prior art is to demarcate the differences between a clinical protocol and a data collection protocol and to establish potential groundwork for associating Kahn's invention and other inventions in the descriptions of art that follow, and to enable cited inventions to retain their internal integrity and attribution as IP belonging to their inventor(s) even as they are combined or reconfigured to work in tandem with one or a plurality of embodiments of the invention described herein.

Stroup, et al. (U.S. Pat. No. 7,512,541) introduces art to manage “medical research study information and laboratory test result information.” As with Kahn, the inventions is directed to “an interactive user interface with elements for setting up a study, managing study member information, managing patient information, receiving and displaying comments”. It expands upon Kahn by “configuring data to be stored in a database associated with the research study” and receiving “medical event information from a user and laboratory test result information from a laboratory information system” to generate a display of correlations across medical events and laboratory test results. These results are then compared through display of indicators of “normal” ranges for the laboratory test results. Divergence from the invention described herein is that the art is actually directed to visualization and computation and has little valence with data collection protocols or with valuations of data supplier contributions.

Hufford, et al. (U.S. Pat. No. 8,145,519) introduces art to develop research data collection protocols for clinical trials in order to track research subject compliance with a research data collection protocol and evaluate a subject's performance in the clinical trial. The system and method provides an embodiment of Hufford's invention that uses a portable electronic device to query and collect data from the subject, which might relate to a data collection protocol, but no features or aspects of such a protocol are described that correlate with those in the art of the patent described herein, and no art for compensation or adjustment of data collection protocols is included in the system and method. DeMeyer, et al. (U.S. Pat. No. 8,065,347) introduces art to manage individual clinical trials running under multiple data collection protocols at once. Art is described to move subjects of one clinical trial to another upon approval from the doctor or hospital managing their involvement in the study. The focus of the art is to maintain the integrity of the data during a change or re-assignment of a data collection protocol, but no art to compensate data suppliers or modify data collection protocols themselves is offered.

Wallach, et al. (U.S. Pat. No. 7,899,685) describes art for a method and system to enable display of real-time clinical trial enrollment data using a set of computer forms for administrators to assign and define clinical trial parameters, including trial protocols, clinical sites, and other groupings. The art assumes accumulation of the data, its storage in a central database, and a dedicated client server connection between the application and the database. The art is essentially oriented to use of an Internet web portal to enable clinical site personnel to enter subject enrollment data and for the database to store and post subject enrollment data as said enrollment data is entered. Said posting also includes a visualization component that retains the relationships of the subjects, the protocols, and the sites. The art does not consider the pervasive computing or distributed approach of the invention described herein, nor is there inclusion of any aspect of data collection protocol modification or compensation of data suppliers or charging of data consumers.

Brown (U.S. Pat. Nos. 7,555,470 and 6,196,970) introduces art by which research data can be collected and analyzed during the course of the research process and the protocol itself modified to account for conclusions drawn from the research data. Differences with art introduced in the invention described herein are that the focus is on implementing what is commonly called an “expert system” or upon linking to an actual physical device, such as a glucose monitor; but there is no inclusion of art for vetting data or for changing the data collection protocols by a data supplier or compensating the data supplier for changes to research questions. Deakter (U.S. Pat. No. 7,401,028) also introduces art to enroll patients in a medical study, in this case by linking the patient to a medical practice database, a plurality of medical specialties, and a clinical studies database with a plurality of medical studies. The focus of the art is upon matching and assignment through a programmed processor and communications to the medical practices participating in the medical studies. The system and method also includes a charging function in which the processor calculates a fee for conducting the study. The art described by Deakter does correlate with aspects of the domain and topic assignment process of the invention described herein, but the arrangements are between groups or medical practices and between clinical research providers and not inherent attributes or features of the data collection protocols themselves. Another way of considering this distinction is that Deakter remains in the traditional organizational relationship paradigm for clinical research and does not consider individual or “swarm” based contributions to data collection protocols of the crowd-sourced system and method of the invention described herein. Even the art describing a calculation and fee component is directed to whole studies, rather than data collection protocols or individual contributions to data collection protocols.

McAlindon, et al. (U.S. Pat. No. 7,251,609) introduces art to use the Internet and a database to conduct clinical trials of test substances and includes: “recruiting and screening for candidates who are eligible to participate in a clinical trial of a test substance using the internet; obtaining, directly from a participant at a remote site, personal information as well as information allowing a determination of any effect(s) of the test substance on the participant after use (e.g., by evaluation forms completed and transmitted over the internet); compiling data from multiple participants.” Obviousness is inherent in the system and method of McAlindon since any research would require the system and methods described, and further, the “evaluation forms” which might be data collection protocols are not described and no systems or methods are described to alter or improve them. McAlindon's system and method does not address art for evolving data collection protocols or compensating data suppliers or assessing the potential value or utility of contributions from a data supplier.

Briegs, et al. (U.S. Pat. No. 7,054,823) introduces art for designing and monitoring clinical trials that includes using a history of prior clinical trials and resources to inform the conduct of future clinical trials. The focus of the art introduced by Briegs is typical of the current practices of Clinical Research Organizations, where the process of administering clinical research requires data links to distributed “databases in the enterprise, e.g., human resources and finance databases.” because the management of clinical research business methods is the focus of the art. Some of the information in the main database concerns prior clinical trials and is, in part, in the form of data collection protocols, yet these differ from research data collection protocols Per se, and focus on records to be used to calculate charges for the overall process of conducting the study, such as: “(a) scheduled visits of a test subject to a treatment site, (b) measurement of prescribed physical attributes of the subject during the visits and (c) administration of at least one prescribed medical product to the subject during the visit to determine over time the subject's response thereto.” Fees for data suppliers and for changes or modifications to data collection protocols are not considered.

Bleicher, et al. (U.S. Pat. No. 6,820,235) introduces art to manage clinical trial data through “dynamically generating, at a server, a data entry form to be displayed at a client. The data entry form is generated dynamically in a SGML-derived language. Control elements within the form comprise images which are used to construct the control elements and larger controls. The form is generated from a protocol database and a context received from the client, is populated from the data database, and is published to the client. Templates based on the protocol database comprise several frames including intermediate frames for displaying frame borders which are non-horizontal and non-vertical. If the trial protocol changes during a trial, the generated form is based on the protocol version active at the time data was entered into the form. Inadvertent use of the application is discouraged requiring an authentication procedure and displaying a picture of the authenticated user. Furthermore, help is provided by creating a link between the text or each question and information about the question. The source of help may be any or all of a protocol document, an investigative brochure, and a study guide. In addition, a user, upon logging in, is presented with a dashboard screen which provides information or links to information such as trial-related news, alerts, statistical information, progress reports and a list of work to be completed.” The gap in Bleicher is that it does not address any art for methods or systems for what Bleicher calls a “trial protocol.” It is further unclear whether said “trial protocol” is a data collection protocol or a clinical trial procedural protocol. The reason for quoting Bleicher at such length is to illustrate the state of the art prior to pervasive computing, crowd sourcing or social networks, and before inclusion of these capabilities enabled real time updating of data collection protocols and pricing and payment for contributions of data suppliers.

Shah (WO/2004/038560) offers art for a system for managing clinical trials that is similar to Bleicher in its inclusion of a Web client, a server, and a patient record database. Shah further introduces art to use a server to run a number of different applications associated with different participants in a clinical trial process. “These applications are divided into core and non-core components. In an exemplary embodiment, there are twenty nine core and non-core components.” The art differs from that of the invention described herein in its orientation to management of the clinical trial business process (also often labeled a “protocol”), rather than the research process. Roles, such as sponsor, regulator, investigator, site, patient, and monitor that are intrinsic to clinical trials are introduced and tools for managing those roles are described for reporting clinical trial information, monitoring clinical trial events, scheduling and tracking appointments, providing good clinical information, closing-out a trial, and displaying views of information to various roles. No art is introduced to enable data collection protocol adjustment or valuing or rewarding input by data suppliers.

Spaulding, et al. (WO/2011/028205) advances the art introduced by Shah through a “system and method for automating the implementation of and collection of data during a clinical trial on living subjects” that is essentially a data input system to link a clinical trial protocol to a clinical trial subject, collect data from the subject himself, and post said data to a database that is linked to a clinical trial business management system. Adjustment to protocols, consideration for contributions, weighting or valuation of data suppliers, or features of crowd-sourced or pervasive computing are bypassed or have no art associated with them. Hotchkiss, et al. (20030140043) offers an invention for a “clinical research data management system and method for a plurality of disparate users”. There is an implication of art introducing crowd sourcing, but the description of the art veers into “a presentation creation mechanism operable to provide users with data from a database, an application control and navigation mechanism operable to service user requests and a data access mechanism operable to access information that resides in the database”. Hotchkiss's database is “operable to store user data and study data. The study data includes candidate data, specimen data, event data and at least one dataset. The dataset is defined using metadata. The database is operable to store at least one role associated with each user. User access to study data, candidate data, specimen data, event data and/or data sets is individually limited based on the at least one role associated with each user”. The criterion of obviousness is perhaps an issue in the description of the art by Hotchkiss, but even if there is new or patentable art, the assignment of views or windows to data for different roles is a common standard for access to databases and display of data stored within them. Changes to what would be “event data” by data suppliers and other weighting and payment and use of crowd sourcing is not included in the art offered by Hotchkiss.

Green, et al. (20110246236) introduces art for a system and method for gathering quality data for a plurality of healthcare providers over an extended computer network. Green, at first glance, implies crowd sourcing, but the art described by Green is directed to a system and method that comprises “an enhanced services server in electronic data communication with a plurality of Electronic Health Record (EHR) systems via a network connection, the plurality of EHR systems being configured to capture patient data for a plurality of patients at the plurality of healthcare providers' sites during a plurality of encounters with each of the plurality of patients, and the enhanced services server being built on the same architecture as the plurality of EHR systems. Electronic quality of care forms are retrieved from one or more form managers via the network connection and a plurality of fields in each of the electronic quality of care forms are automatically populated using the patient data captured by the plurality of EHR systems. The completed electronic “quality of care” forms are then automatically transmitted to one or more form receivers via the network connection, the one or more form receivers being one or more organizations that process quality of care data to qualify healthcare providers for at least one of certifications, accreditations, and monetary incentives”. The art of the invention described herein could well integrate with the art described by Green in one or a plurality of embodiments of the invention described herein, but there is no overlap of claims because the focus of Green is on coordination of medical records rather than data collection protocols.

Tkaczyk, et al. (U.S. Pat. No. 7,870,006) describes a method for managing clinical study information using a server coupled to a centralized database with at least one client system. Data collection protocols are perhaps a variant of a “template” described by Tkaczyk and are stored within the database and contain a reference to “at least one patient involved in a clinical study wherein the clinical study information is entered through a user selected template displayed on the client system, storing clinical study information received at the server system in the centralized database, tracking clinical study information stored in the centralized database, updating the centralized database periodically with newly received clinical study information to maintain clinical study information, and providing clinical study information in response to an inquiry.” Tkaczyk offers no art for updating said templates or compensating data suppliers. Tkaczyk's traditional business process and client server model for management of clinical studies represents the typical art for the industry as of the initiation of the application for a patent for the invention described herein.

Choi, et al. (U.S. Pat. No. 6,895,405) introduces art for refinement of survey questions which are part of the data collection protocols of the invention described herein. Choi introduces a computer-assisted method “for determining a potential effectiveness of a survey question. The disclosed method includes segregating a plurality of responses to a survey question into a plurality of categories, and determining a response distribution for each of the plurality of categories. The disclosed method also includes calculating a box score and a difference score for the survey question from the response distributions, and using the box score and the difference score to obtain an effectiveness score for the survey question.” There is no overlap in claims with the invention described herein, but the interest in developing methods to improve the quality of items within data collection protocols and to define categories which could correlate with the use of the term “domain” or “topic” in the invention described herein is synergistic.

Taylor, et al. (20040006566) introduces art for “a system and method for addressing the paradoxes and problems associated with the Knowledge Economy, and the transition to it. The system and method of the present invention (Taylor's) create a unified experience of work that scales from individual thought processes to the building and using of a global system of commerce. Described in several levels of recursion, the system and method of the present invention (Taylor's) integrate, into a single system and method several discrete Sub-Systems and methods that comprise a myriad of now unintegrated tools and processes that are conducted across contradictory and non-collaborative environments.” Taylor is cited because he describes art to leverage pervasive computing and crowd sourcing and distributed data inherent in the invention described herein. There is no overlap in claims, but there is an overlap in Taylor's macro frame of reference regarding broadly distributed contributors, and pervasive computing. Boyd, (WO/2006/086525) integrates, advances, and applies the art described by Taylor to use the Internet for research with specific attention to clinical research describing embodiments that; “comprise a tool kit for the design and execution of research protocols, for example, comprising a web-based research protocol composer for generating a data processing protocol; a collector for collecting data entered via an internet based questionnaire; a database for data; and a protocol processing routine for processing data and generating an output. For example, the toolkit suitably serves as a ‘hub’ of a global research environment (e.g., connected via the Internet or other network) that creates and connects communities of researchers and facilitates the sharing of software and results. Additionally, the present invention (Boyd's) provides standardized and custom online ‘programs’ or ‘scripts’ (referred to herein as ‘protocols’) that define and guide events in experiments, clinical trials, surveys, and other kinds of studies. These protocols are created and executed online”. The potential overlap with the invention described herein is Boyd's “protocol composer for generating a data processing protocol” and a “collector for collecting data entered via an internet based questionnaire.” Inspection of the actual systems and methods of the toolkit described by Boyd and the claims associated with Boyd's invention diverge from the invention described herein primarily because Boyd links a data collection protocol to a single data supplier and does not enable shared contributions by multiple data suppliers into the same protocol, nor does Boyd enable compensation for data suppliers.

Art introduced by Marks, et al. (WO/2004/102333) focuses on verification of data, verification of training for contributors of data, and verification and calculation of fees if milestones for a clinical study are achieved. Marks does not consider verification of data collection protocols, data suppliers, and questions within data collection protocols. Lawyer, (U.S. Pat. No. 8,126,882) does address the credibility of data suppliers by describing art to address the credibility of a person who posts content online through “obtaining at a first computer an online content item authored by an author for public online display” that is assigned a credibility factor for said online content item based upon data associated with the data supplier. The invention described herein differs from the art described by Lawyer because the ranking and weighting is directed specifically to apply to the insertion of a change or addition to a data collection protocol, not an online post. Zacharia, et al. (U.S. Pat. No. 6,895,385) also introduces art for “ascribing a reputation of an entity as a rater of other entities . . . . A first rating indicative of a rating of a rated entity by the first entity, and one or more second ratings, each second rating indicative of a rating of the rated entity provided by another entity, are provided. The second ratings are combined to produce a first combined rating. The first rating is compared to the first combined rating to produce a first rating predictability of the first rating, the first rating predictability being a negative function of a magnitude of a difference between the first rating and the first combined rating. A resulting rater reputation is generated based at least in part on the first rating predictability”. This simple method can readily be associated with embodiments of the present invention, but there is no overlap in claims.

Vander Mey, et al. (U.S. Pat. No. 7,822,631) introduces art that considers credibility of data suppliers through “managing content by identifying content that has attributes of interest (e.g., content that is useful, humorous and/or that otherwise has a sufficiently high degree of quality) and by determining how to use such identified content. In some situations, a piece of content is automatically assessed in a manner based on automatically assessed levels of trust in users who are associated with the content, such as a user who authored or otherwise supplied the content and/or users who evaluated the content. For example, an automatically assessed level of trust for a user may be based on prior activities of the user and be used to predict future behavior of the user as a supplier of acceptable content and/or as an acceptable evaluator of supplied content, such as based on prior activities of the user that are not related to supplying and/or evaluating content”. This art may also be associated with an embodiment of the invention described herein, but there is no overlap in claims or methods.

Keller, et al. (U.S. Pat. Nos. 7,672,868 and 8,140,380) introduces art for a ranking of reviews to reward authors of said reviews according to calculations of the value of the reviews. Embodiments of the invention described herein may include the methods and systems described by Keller, but there is not conflict in claims, since Keller is directed toward reviews of products themselves, not with data collection protocols. Hillis, et al. (U.S. Pat. No. 8,069,175) provides “an evaluation system for reliably evaluating large amounts of content. The evaluation system is managed by a primary authority that designates one or more contributing authorities by delegating to each a specific quantity of authority. Each contributing authority may in turn designate and delegate authority to one or more additional contributing authorities, subject to the restriction that the total quantity of authority delegated does not exceed the quantity of authority the contributing authority was itself delegated. Each contributing authority, and optionally the primary authority itself, may evaluate one or more portions of content by associating a rating with each evaluated portion of content. A composite rating for a particular portion of content may then be determined based upon the ratings associated with the portion of content. Preferably, the ratings are combined in a manner that affords a higher priority to the ratings provided by contributing authorities to which a greater quantity of authority was delegated”. The hierarchical cascading crowd-sourced evaluation of content and application of ratings to said content described by Hillis differs from the claims of the invention described herein in that; the object of the process for the invention described herein is directed to data research protocols Per se; and use of the ratings from the system and method of the invention described herein is for calculation of value or fees for specific contributions of questions to insert into data research protocols or to draw down data collected through data research protocols.

Sarbaev, et al. (U.S. Pat. No. 8,090,666) introduces art to associate “a first participant and a second participant in a social network” that includes payment for said association. The invention described herein also uses the features of a social network; however Sarbaev designates fees as exchanged for the right to “follow” another participant in a social network, not to draw down data from the federated or aggregated data generated through the system and method of the invention described herein. Malek, et al., (U.S. Pat. No. 7,308,418) also leverages participants in shared or collaborative (social) networks. “Disclosed are methods and apparatus for conducting market research and developing product designs. The methods involve generating and presenting, typically electronically, generations of design alternatives to persons participating in the design, selection, or market research exercise. The participants transmit data indicative of their preferences among or between the presented design alternatives. Some of the data is used to conduct a conjoint analysis or non-convergent exercise to investigate the drivers of the preferences of the group or its members, and at least a portion are used to derive follow-on generations of design alternatives or proposals. The follow-on designs are preferably generated through the use of an evolutionary or genetic computer program, influenced by the participants' preferences. The process results in the generation of one or more preferred product forms and information permitting a better understanding of what attributes of the product influence the preferences of the test group members.” Iterative concatenation as used by Malek could potentially be included as an option for an embodiment of the invention described herein, but there is no overlap in claims or art, only a potential for synergy.

Lesandrini, et al. (20030036944) does offer a use of crowds sourcing and pervasive computing by describing “an extensible business method for performing research over the internet is presented. A first community web site is provided for a first targeted industry. User profile and feedback information is gathered from the users of the first community web site. The gathered user profile and feedback information from the first community web site is provided to at least one subscribing client of another web site. This method may be duplicated by repeating the above steps to a second targeted industry. In one example, a method for performing on-line consumer research over the internet is implemented comprising the following steps. User reaction of at least one user to at least one advertisement displayed on a first web site is gathered. Then research information is provided to a subscribing client on a second web site, based on the gathered user reaction on the first web site.” Again, as with Malek, concatenation and iteration are embedded concepts, but there is no conflict with the claims of the invention described herein.

Frengut, et al. (20060064342) introduces a crowd-sourced research method that illustrates a significant difference between the system and method of the invention described herein with other art related to research. The invention described herein assumes intermittent, sporadic, discontinuous, and sparse input from a distributed “crowd” or “swarm,” rather than a single event where many participants contribute at a single point in time to a dataset. Here is how Frengut describes his method for “conducting an online research study from a host machine over a distributed computer network. Through their computers participants attend the online research study conducted over a distributed computer network and/or in communication with a moderator using a participant interface having an audio/video captive mechanism connected thereto. Each participant is not required to be physically present at a same geographical location as a moderator for the online research study. The system permits for substantially real time audio/video communication between the moderator and participants during the online research study. The online research study can also be streamed in real time, while ongoing, one or more client computers who also are not restricted to any geographical location. Two-way communication between the moderator and a designated client can also be permitted while the online research session is being conducted. In another embodiment further embodiment, the system provides audio and video recording capabilities that can combine or encompass any various combinations.” This approach to research can well be included as a portion of a research process associated with the invention described herein, but changes in symptoms or opinions or occurrences in real time and observation and entries into structured data collection protocols of these sparse and sporadic changes are not enabled by most, if not all prior art, resulting in many data collection and entry processes similar to the method of Frengut, and dissimilar to the system and method of the invention described herein.

Mizrahi; et al. (20060155513) introduces a crowd sourcing approach to conducting a survey that “includes providing a plurality of questions to respondents, at least some questions being provided to a plurality of the respondents, collecting answers to the questions from the respondents, transferring at least some of the answers to respondents other than those who generated the answers, collecting responses to the transferred answers, at least some of the responses being qualitative, and providing a statistical report which is at least partially based on qualitative responses collected from the respondents.” While there is no overlap of claims with the invention described herein, Mizrahi does apply a method that implies iterative concatenation across a distributed network of linked users that might well be a social network or a crowd or swarm. Note how similar Zerba; (20070203426) is to Mizrahi as she introduces “a method and apparatus for obtaining real time emotional response data over a communications system . . . . A stimulus is presented to at least one participant using the communications system. Emotional response data for each participant is recorded while the stimulus is being displayed. The stimulus can be a visual and/or audio presentation such as an advertisement with static or moving images, marketing information, brochures, sales information, live or recorded speeches, debates, television programs, movies, videos, music, computer graphics, computer games or any other media which can be projected audibly and/or visually over a communications network. The recorded emotional response data is analyzed to determine at least one critical emotion range in the stimulus.” Zerba in (20070250484) offers an expansion of her approach with a “perception research system and method is configured to combine aspects of both quantitative research and qualitative research. The perception research system includes a user interface that allows users to interact with the system based in part on the graphical nature of the user interface to form qualitative associations between various concepts expressed through image cards, text cards, ranking inputs, and group icons. The system allows for record capture of statistics associated with the qualitative associations expressed by users through their interaction with the system to allow for later quantitative analysis of the expressed qualitative associations. By combining the quantitative and qualitative research worlds, the system offers a way to develop, test, and validate understanding of perceptions of humans such as involving consumer perceptions of new products, branding strategies, and other creative concepts using ethnographic and other methodologies combined with statistical expression of such.” The extension of Zerba's invention to shaping and structuring domains could be associated with one or a plurality of embodiments of the invention described herein, but no claims of the invention described herein could conflict with those of Zerba in (20070250484).

Linking domains and topic through crowd sourcing and social networks is introduced by Ward, (20110137845) through “a method and apparatus for real time processing for mediating Social Media posts to a Social Media Network wherein a Semantic Filter Algorithm is provided. The Semantic Filter Algorithm is an application of Shannon's Entropy algorithm that functions to assess comparative contextual relationships between linguistic signifiers in a multiple of databases. Social Media posts are received by the Social Media Network and are automatically directed to Semantic filtering in multi-passes through the Semantic Filter Algorithm. The posts are automatically processed and an output is generated. Responsive to the output the posts are automatically allocated according to category and prioritized. Metatags are attached to the posts to control further processing regarding the various categories.” While Marks has no conflict with the claims associated with the system and method of the invention described herein, his methods could also operate synergistically with the identification of domains and topics of the invention described herein. Srinivasan, (20110137705) also addresses content domains and topics through his “method and a system for automated content analysis to assess impact on one or more business organizations. Content is aggregated from at least one content provider. The aggregated content is classified in knowledge ontology on the basis of a plurality of attributes of the content. Subsequently, a score is assigned corresponding to the impact of the classified content on the business organization in accordance with a set of scoring rules. Finally, a graphical representation is generated showing a cumulative score corresponding to the impact of the content on the business organization assessed during a predefined time period.” These inventions do not step upon the claims of the invention described herein, but they are part of the prior and current art for generating classification and organization of domains and topics of the invention described herein.

Martin; et al. (20090182580) introduces art to disseminate or distribute data gathered into datasets. He claims: “embodiments provide a system and method for automatedly aggregating medically related data and disseminating different sets of the aggregated data to two or more different members of a medical care provider. Some embodiments automatedly and intelligently disseminate the aggregated data such that the data that is written once to the data storage solution is usable for a multitude of purposes within the functions of the medical care provider. Some embodiments intelligently disseminate the aggregated data by disseminating only relevant sub-components of the data to different members of the medical care provider based on the needs of the members such that different members receive different subsets of the data.” While there is no overlap in claims, there is a common interest in the patent described herein to distribute information to the right party based on the data posted into a data collection protocol, aggregated into a dataset, and then distributed. August, (20090070200) approaches the same concern as that addressed by Martin (20090182580), but in his case, introduces an “online research system delivers allows (confusing language not the language of the present inventor, but of Martin) a researcher to script queries to be delivered to research participants, delivers the queries, collects research participant feedback, and aggregates the feedback for review and analysis by the researcher. Tools are provided which allow queries to be rapidly and easily scripted, and the researcher may situate the queries along a timeline to schedule their automatic delivery. Researchers may assign “tags” to feedback, wherein researchers may select content from feedback and apply a label, and thereafter rapidly access this content by referencing its label. As a result, researchers are able to rapidly catalogue useful content for use in compiling their findings regarding research participant feedback.” This cataloging also enables domain and topic identification to be accomplished, but does not overlap the art of the patent described herein. Menschik, et al. (U.S. Pat. No. 7,523,505) also has an approach to “a network for mediating the peer-to-peer transfer of digital patient medical data includes a plurality of distributed agents each associated with a health care provider and connected to a central system.” Rather than the real time approach of the invention described herein, Menschik has an agent “periodically . . . collect local information relating to patient medical files and/or data streams, for example diagnostic images and associated reports, and process that information into metadata files acting as pointers to the original files. The metadata files are transmitted to the central system where they are parsed and the attributes are stored on the central system in patient records with records from the same patient grouped together whenever possible. Registered users can search the central system, even in the absence of a unique identifier, to identify patient records pointing to the remote patient medical files. Upon finding a patient medical file, the invention provides a streamlined process for communicating access authorization from the patient to the hospital or facility storing the medical files. Once patient authorization is received, secure processes are provided for transferring the data in its entirety to or for viewing by the user in a peer-to-peer fashion”. The implementation of concepts regarding remote access, unique parsing and linking of data to what invention described herein organizes into a “domain” or “topic,” but is configured by Menschik into a “metadata file;” and the allocation and authorization to transfer or access or share data by different data consumers provides a good example of how the invention described herein advances prior art. The invention described herein enables fees and charges for differing layers and options for real time access and sharing as well as enabling data files to be vetted and updated in a much more expansive manner than the “patient medical files and/or data streams, for example diagnostic images and associated reports, and process that information into metadata files acting as pointers to the original files.” Claims across the inventions do not overlap, but the objective of ready access to data is shared.

The closest method for iterative protocol configuration and posting discovered through the search conducted by the inventor of the invention described herein is Afeyan, et al. (U.S. Pat. No. 7,016,882) which describes an invention for “generating and presenting, typically electronically, a number of design alternatives to persons who are participating in the design, selection, or market research exercise. The participants (referred to as “selectors”) transmit data indicative of their preferences among or between the presented design alternatives, and that data is used to derive a new generation of design alternatives or proposals. The new designs are generated through the use of a computer program exploiting a genetic or evolutionary computational technique. The process is repeated, typically for many iterations or cycles.” Even though the claims do not overlap and the invention is not related to the kind of research processes of the invention described herein, Afeyan does describe a variant of the use of an iterative technique to improve upon a process through crowd sourcing.

As can readily be deduced from the multitude of citations of prior art related to the invention described herein, the art crosses multiple disciplines. Conclusions that may be drawn from the review of the search results for prior art is that the field is exceptionally fluid due to transitions in business methods and systems utilized by the invention described herein; crowd sourcing, pervasive computing, real-time communication, distributed data, inclusion of both qualitative and quantitative data, and the need—and now ability—to use both push and pull methods and incentives and compensation to drive in-course adjustment of research data collection protocols and data collection itself for a vibrant and effective data supply chain.

### BRIEF SUMMARY OF THE INVENTION

A marketing platform for coordination of a data supply chain for data suppliers, data consumers, and advertisers or sponsors implemented through a system comprising: a social network enabling crowd sourcing through one or a plurality of electronic devices accessible through the Internet, one or a plurality of datasets distributed on the one or a plurality of electronic devices accessible to the crowd-sourced social network, each dataset housing one or a plurality of data collection protocols browse able on one or a plurality of electronic devices capable of functioning as a server and implementing computer readable code to enable both push and pull methods for real time collection and real time distribution organization and display of data associated with said data collection protocols; said system enabling collection, vetting, weighting and distributing of data collection questions to be associated with one or a plurality of data collection protocols; said system enabling collection, vetting, weighting and distributing of data collection protocols containing one or a plurality of data collection questions related to a knowledge domain or target or topic of data collection, either qualitative or quantitative or both; said system enabling assignment of collateral associations with variable file types and variable database objects; and assigning one or a plurality of compensation or consideration exchanges or schemas including one or a plurality of a price, subscription value, access fee, viewing charge, or download price to data consumers, and one or a plurality of charges for advertising or sponsorship or posting of banners or other forms of embedded promotion of said advertiser if said advertiser is assigned to one or a plurality of said data collection protocols.

### BRIEF DESCRIPTION OF THE DRAWINGS

FIG. 1 Roles, Rights, Actions

FIG. 2 Functions, ID Assignments and Processes

FIG. 3 Diagram of Protocol Interactions

### DETAILED DESCRIPTION OF THE INVENTION

Properly designed research can mitigate the risks posed by medications and other products produced for sale or distribution to consumers. Defects in manufactured products or in biological, chemical, or medical devices and equipment can result in significant harm or loss. Indeed, a diversity of products or services may pose a risk to users, purchasers or recipients. Tools that enable the implementation or improvement of research data collection protocols and the quality of data input into research data collection protocols to be used for data analysis or to trigger notifications and feedback to manufacturers, providers, users, regulators, and other vested parties will enable early identification of and therefore early warning of emergent problems and inform decisions to delay or halt production of products or services that may pose a risk to consumers. Distribution of the data enabled through the system and method of the invention described herein to regulatory agencies, manufacturers, service providers, and individual end users of products and services will enable better management of risks and liabilities in real time. Incentives for contributions of research questions and participation in the vetting and contribution process to improve research data collection protocols are enabled through the invention described herein to encourage abet or facilitate researchers and others to participate in a data supply chain. Additionally, assigning values, fees and prices, social recognition, and other rewards to participants in a data supply chain can structure and rationalize widely distributed yet flexible participation.

The invention describes art for a system and method implementing a collection and distribution platform for data suppliers and data consumers to use crowd sourcing and social networking to enable data suppliers to contribute data collection questions to data collection protocols and post data into said data collection protocols aligned with said data collection questions; for data consumers to access and purchase said data collection data; for data providers to be compensated for their contributions; for knowledge publishers managers and distributors to leverage value for data collected through data collection protocols for data they opt to include in articles or manuals or other products using data collected through said collection and distribution platform or data supply chain; and for advertisers to sponsor data collection or to associate their banners or other advertising copy or database objects to link data suppliers or data consumers to said advertiser through one or a plurality of data collections questions, one or a plurality of data collection protocols, and/or one or a plurality of domains or targets or topics associated with groupings of data collection protocols. Further, the system and method enables the data supplier or data consumer to retain a link to said data collection questions and said data collection protocols along with weights and values assigned to and associated with said data suppliers; and also to configure link and store associations with domains and topics associated with data collection questions and data collection protocols.

The Department of Homeland Security and the FDA are encouraging development of systems and methods for capturing positive or adverse impacts of biological and chemical agents or equipment that may be distributed through emergency response channels or through standard retail and other distribution channels and outlets during emergency events. Linking data suppliers into research processes, especially research on vaccines pharmaceuticals or medical devices, will support statutory and regulatory requirements to assess risks and other data or information prior to regulatory approval or inclusion into distribution networks. Studies of long term effects and interactions of medications or services, such as medical procedures, also may uncover unanticipated adverse effects. Real time research, clinical or otherwise, can support national and international objectives for the sustainability of our species and our planet.

The term “data supply chain” is intended to describe a linked system of data contributors, data collection protocols and formats for collection of data, data from automated entry and posting processes, input from persons that vet audit and analyze data, and triggers and other processes and calculations that mark achievement of positive or negative thresholds for further actions by participants, and server events generated by markers or thresholds. The term “data supply chain” further implies and includes server or electronic device and human actions resulting from trigger thresholds being reached or surpassed; communications, notifications, or additional server or electronic device actions involving data suppliers and other participants; and other forward or backward chains of server or electronic device actions, including allocation of transaction fees, prices, awards, charges for placement of advertising banners, and other exchanges of social or physical currencies among participants in said data supply chain and process.

The value of a right or a role within a data supply chain will vary. Data suppliers who contribute observations or data may be allocated a payment or other reward or consideration per contribution or per set of contributions; while those who review or audit observations may be allocated a different level or type of payment or reward. In contrast, data consumers who access a portion of a data supply chain may be charged a fee for the right to view or download or access said portion of the data supply chain, or may be assigned a right to receive a notification or other action resulting from the operation of the data supply chain. The allocation of payments or charges will vary according to the value propositions and decisions of managers and other users of the data supply chain regarding rights and roles for interaction with said data supply chain. The fair and open market exchange and trading platform of a data supply chain is intended to be in support of and a reflection of a free market economy and transparent fair and just pricing and exchange for services. Implementation of a data supply chain should improve the quality of the data supply and enable respect for and attribution of intellectual property rights as the expansion of pervasive computing enables a broadly accessible diversified and flexible data trading platform.

The invention herein specifies a particular relationship to the data supply chain of a “data supply chain manager” who is enabled to manage registrations and user rights and processes for inclusion into the data supply chain and enable payment for modifications to a data collection protocol and other interaction with the data supply chain. A second relationship to the data supply chain is that of a “data supplier” who contributes to processes and content of one or a plurality of research data collection protocols Per se, such as; structuring a research data collection protocol, inserting new research questions into a data collection protocol, and vetting questions for inclusion into a data collection protocol. A data supplier may be an electronic device capable of generating computer readable code or optical images convertible to alphanumeric strings of characters or radio signals convertible to code readable by electronic devices. The invention further specifies a relationship to the data supply chain of a “data consumer” who draws down data from the data supply chain in order to perform analysis or develop reports or other publications that include the data. A data consumer may also be an electronic device capable of generating computer readable code or optical images convertible to alphanumeric strings of characters or radio signals convertible to code readable by electronic devices. A single individual or device may function in roles of data supply chain manager, data supplier and data consumer. Further, service providers or product manufacturers may elect to have the role of an “advertiser” or “sponsor” through a link into the data supply chain to associate or advertise their product or service with the data supply chain in exchange for fees or other consideration. A further role within a data supply chain is assigned the label of a “beneficiary.” A beneficiary is a role such as that of a regulator or emergency services provider who is not involved in data collection or financial or transactions, but who is intrinsic to a research process and must have access to data obtained through said research process in order to protect or serve the public interest. Often a beneficiary serves as an ombudsman for data quality, but the significant distinction is that they are only in exceptional circumstances part of the fee exchange or reward systems used for contributions to the data supply chain.

Structuring input into a disciplined research process included within a well designed data supply chain will advance the public interest. The invention described herein can further be folded into any of the processes for offering reviews and feedback through social networks and through direct registration or subscription to feedback formats and processes on websites managed by manufacturers or producers as well as by software as a service (SaaS) vendors. Quantitative and qualitative data as well as data objects or images that may be converted into computer readable code by further processing on an electronic device, such as optical matrix codes, are intended to be collected through a data supply chain and associated research data collection protocols. In Smith (Ser. No. 13/271,157), of which this invention is a continuation in part, Smith describes a group of four fundamental components of a data supply chain as “Delta4C:”

1. C1=Connect and enroll all involved parties or participants rapidly and effectively from a distributed network to properly include and assign observers into a process for contribution to the data supply chain;

2. C2=Collect real time observations from a full circle of contributors with variable weighting for reputation and access to relevant information;

3. C3=Compute the values and ratings of accumulated observations to assess whether thresholds for risks or alerts have been met or surpassed;

4. C4=Communicate or notify the right parties regarding information that is actionable for them.

The method and system of the invention described herein focuses primarily upon the term labeled “C2” in the list and structures how “relevant information is to be collected and vetted and weighted.”

The system and method of the invention described herein can be applied to any subject or topic for research, such as biological or social or environmental interactions. The system and method of registration or inclusion of a data supplier or consumer may be enriched to include sufficient information about these registrants to enable real time notifications and communications to be tailored to inform and instruct registrants regarding actions to undertake in response to emergent or unique situations. The FDA has begun to consider tools and mechanisms for a “flexible, nimble system to produce medical countermeasures rapidly in the face of any attack or threat, known or unknown,” and the rapid updating and upgrading of data collection protocols for capturing observations from data suppliers regarding risks and liabilities along with real time notification processes will facilitate achievement of that objective. The data supply chain and accompanying infrastructure will enable the goal of the FDA's MCMi regulatory science program (Pillar 292 II): “to facilitate, simplify, and speed the development and evaluation of medical countermeasures by . . . risk communication to improve public health outcomes, . . . and real-time tracking and evaluation of MCM safety and efficacy during public health emergencies.” There are significant benefits to meliorating risks through capturing real time observations from a full circle of observers and to proactively notify regulators, providers, patients or other recipients of services or products, as well as manufacturers, suppliers, distributors, and service providers as said risks are identified. Easing processes to enable every responsible party and every user of a medication or medical device or product or service to contribute weighted, vetted, context rich data regarding side effects, drug interactions, contamination, manufacturing defects, or other potential concerns before they endanger larger groups of consumers or escalate into liabilities will make consumers safer and provide emergency responders with actionable intelligence as they formulate policy and determine courses of action.

Some embodiments of the invention described herein will implement the system and method of the invention as a business process that formats and organizes data collection questions inserted into data collection protocols as steps or stages of a business process or as milestones for the achievement of goals or objectives or as volumes or quantities or types of resources or products or materials or even as requests for advice or counseling or coaching or opinion. Responses to said alternative formats for data collection questions are still data, and still merit compensation and other processes enabled through the system and method of the invention described herein, but their use may be for improved or enriched business decisions or for activities other than research Per se.

The standard use for data collection protocols is for clinical research, but the typical clinical research protocol includes more than is meant by “data collection protocol.” In clinical research a “protocol” describes which classes or types of persons may participate in a clinical trial or a clinical study; the schedule of tests, procedures, medications, and dosages; the length of the study; business processes related to regulatory or statutory requirements; and business processes related to administrative and other services and processes. Use of the term “data collection protocol” is more specific and more restricted and refers to the format and organization and configuration of structured electronic forms to accept and display and process research questions that are sequenced and ordered and posted into a data collection format accessible through electronic devices capable of processing computer readable code. The invention described herein can further be applied to business data collection processes and processes associated with behavior of persons operating as representatives of agencies or organizations in a fashion similar to the system and method of the invention for capturing data regarding impact or consequences resulting from use of a service or product or for laboratory or other research. Examples of research processes that are also business processes are employee performance appraisal; tracking of attendance; inventory control; advice offerings; or customer feedback. Indeed, any formally structured data collection format for a business can be converted into what is described in this invention as a “data collection protocol” with the incentives and vetting of the claims of the invention described herein being options or choices to be made by one or a plurality of members of an organization, a crowd or a social network according to one or a plurality of roles designated for participating as data supplier, data consumer, or beneficiary. A further feature and capability of the invention described herein is the ability of the data supplier to supply data that is qualitative as well as quantitative.

The data consumer is enabled through the system and method of the invention to enter queries and review displays or receive datasets in order to organize construct and compose articles, reports, blog posts, presentations, training or teaching materials or manuals, and implement other uses of the data for knowledge management and knowledge distribution. Further, the system and method enables the use of distributed electronic devices capable of implementing computer readable code to push one or a plurality of instructions and updates to the organization and configuration of the system and method for the data supply chain, including adjustments to protocols and methods associated with said protocols and to accept pull requests or queries for adjustments to questions to be associated with data collection protocols; thus enabling flexible variations within data collection protocols for data to be collected posted and distributed through server actions orto post queries or process other requests for data transfer or display.

In one embodiment, data collection protocols are configured to receive, accept, organize, post, and store observations or entries collected from multiple data suppliers; and further, data consumers are enabled to search or browse for domain or target or topic data and purchase said data for viewing, download, or re-use. In another embodiment, the system enables a user to function as both data supplier and data consumer by purchasing rights to contribute data or collect data through one or a plurality of subscriptions to one or a plurality of data collection protocols associated with one or a plurality of data collection domains, targets, or topics. Further, said embodiment enables compensation of data suppliers based on the number of times their data is purchased by data consumers and the cumulative value assigned to the data supplier for data contributed by said data supplier into a dataset associated with a data collection protocol. An example of an application of said embodiment is one where producers of products insert data regarding availability and prices of products into a data collection protocol and consumers of said products are notified in real time of the availability of said products. A more specific variant of said embodiment is to use the system and method of the embodiment to reduce waste by enabling farmers to use the data supply chain to notify consumers of the availability of farm produce as said produce is harvested and made available for sale to consumers within one or a plurality of geographic ranges, one or a plurality of price ranges, and one or a plurality of volumes. Said variant of the embodiment may also post images and other descriptive terms and qualifiers for said produce.

In another embodiment, the system enables registration of a data supplier or a data consumer into the collection and distribution platform by converting optical codes transmitted from mobile devices into alphanumeric strings to be matched to one or a plurality of data collection protocols associated with a domain or target or topic of data collection and the data supplier associated with said one or a plurality of data collection protocols.

In another embodiment, information about a data supplier is collected organized and weighted to calculate a value for one or a plurality of contributions of observations into one or a plurality of datasets associated with data collection protocols associated with said data supplier. The system and method further enables assignment of a weight or value to a data supplier based upon demographic and biographic and work product data searchable through the internet or offered for verification by said data supplier in order to assign a value to data collection questions offered by said data supplier or to a assign a value to data contributed into data collection protocols by said data supplier, the weight being used to calculate fees or payment or awards or other consideration for contributions by said data supplier to the data supply chain. Said embodiment also enables the assignment of a data supplier to multiple domains in accordance with demographic or Biodata attributes associated with said data supplier. In another embodiment, a data consumer is able to select and purchase a subset of accumulated and weighted data or observations drawn from a dataset associated with a data collection protocol according to criteria or search terms selected or entered by said data consumer from a table or list of one or a plurality of criteria. Said embodiment can be granular to the level of a searchable character string within the data supply or can be accessed through hierarchical tree and branch structures beginning with macro level subject or knowledge domains.

An embodiment that leverages the system and method of the invention described herein enables one or a plurality of a data consumers to post one or a plurality of data collection questions into one or a plurality of data collection protocols associated with a class of domains that accumulate advice or best practices associated with said one or a plurality of protocols to obtain information from the crowd or a social network of vetted and weighted data suppliers to address a problem of concern to said one or a plurality of data consumers. The data supplier in said embodiment operates in the role of an advisor or counselor or coach or consultant by interpreting the question posted into said data collection protocol as a “request for advice or counsel or best practice” and said data supplier enters responses to said questions as counseling or coaching or best practice advice. In this embodiment, the weight of the data contributor is included along with the advice offered in order to calculate one or a plurality of fees or other consideration for said advice and to enable the data consumer to select from advice offerings by weight of the data supplier or other criteria associated with said one or a plurality of data suppliers. The real time advantages for notification and consultation across members of a crowd-sourced or social network is leveraged significantly though this embodiment of the invention described herein. Unlike Wikipedia or other information accumulation tools and methods available through the Internet, said embodiment enables structured and organized responses from weighted and vetted data suppliers to be accessed by data consumers for fair and appropriate consideration or fees to be traded in real time and enables successive improvements to best practice or coaching content through structured crowd-sourced iterative responses to problems or requests posed through questions from data consumers. The data consumer participating in said embodiment may also rate the quality or accuracy or utility of said one or a plurality of responses thereby adjusting the rating of the data supplier serving as advisor or consultant or coach, thus enabling iterative improvement in advice and counsel offered in response to one or a plurality of questions in one or a plurality of data collection protocols. A variant of said embodiment is inclusion of an algorithm to rank responses and to present said responses in order of quality calculated through cumulative ratings of the crowd of data consumers accessing said responses. In another embodiment, the data supplier or data consumer previews a data collection protocol and questions associated with said data collection protocol prior to a decision to contribute data or to purchase data associated with said data collection protocol. This enables the “sampling” by a prospective data consumer of the data available in this segment of the data supply chain. In another embodiment, hyperlinks and other relationships to values and weights associated with data collection questions and data collection protocols and data suppliers are retained within products that include or utilize or organize or present said data collection(s), such as journal articles or blog posts or knowledge management services; such that the consumer of said products may be charged a fee that apportions value for use of the data drawn from one or a plurality of datasets associated with said one or a plurality of data collection protocols. A further feature of the immediately preceding embodiment enables a contributor of one or a plurality of data collection protocols or one or a plurality of questions within said data collection protocols or one or a plurality of data entries to be compensated in proportion to the volume or quantity or quality rating or weighting of their contribution. A further feature of the immediately preceding embodiment is the inclusion of a roll-up or cumulative value or weighting of the aggregated data included within the product to be used by a consumer or reseller or distributor of data collection results as part of the determination of the value or utility of the knowledge product upon publication and distribution.

In another embodiment, one or a plurality of advertisers may preview a data collection protocol and questions associated with said data collection protocol prior to a decision to request the data supply chain manager to enable the one or a plurality of advertisers to purchase the right to associate a banner or a link or optical code or other advertising content or social media linkage or connection with said data collection protocol. A variant of the immediately preceding embodiment is the option for an advertiser to participate in a bidding or auction process for an association with a data collection question or a data collection protocol or a data collection domain, target, or topic. In another embodiment, an author or blogger or other compiler of research data may preview a restricted set of data collected through a data collection protocol prior to a decision to request of the data supply chain manager to enable the prospective purchaser of the data the right to purchase the dataset or a subset of the dataset to insert into documents, research reports, blogs, and other publications on a subscription basis for data that changes or is updated or for data that is purchased on a one time basis. A variant of the immediately preceding embodiment is the option for a data consumer who combines or aggregates and reports data through blog, posts, or other forms of academic or general publication to participate in a bidding or auction process for an association with a data collection question or a data collection protocol or a data collection domain, target, or topic. An embodiment of the invention described herein will also apply statistical or mathematical calculations to arrive at a value or price for the data being requested based upon the multiple variables associated with the data; such as the value of the domain or topic or subject, the value of the protocol, the value of the questions within the protocol, the value or rating of the one or a plurality of the data suppliers associated with the data, or any combination of factors to arrive at a fair market price for the dataset in the context of a data supply chain.

In one or a plurality of embodiments of the invention described herein, automated online payment and other banking or financial transactions involving one or a plurality of participants in the system and method are calculated and may be presented through electronic transmission of notifications to the one or a plurality of participants in the data supply chain for acceptance or approval prior to implementing the one or a plurality of financial transactions.

An embodiment of the invention described herein may be combined with one or a plurality of other embodiments according to the configuration of a data collection process associated with a domain of knowledge or a target of data collection or a topic of data collection. Further, any combination of embodiments may also be configured to integrate with one or a plurality of extant systems and methods for a data supply chain or data collection process. Many examples of prior art have been introduced in the discussion of the background of the invention described herein. It is expected that the invention described herein may be enabled to operate in tandem or in parallel with one or a plurality of those systems and methods or with other systems and methods that involve crowd-sourced data and pervasive computing enabled through multiple linked electronic devices using Internet access or wireless or radio or other spectra that are currently available or may become available to collect and distribute data across electronic devices to members of a crowd or social network.

An operational description of an example embodiment within the business processes and methods for clinical research follows: A Pharmaceutical manufacturer develops a new medication and determines to become a sponsor of research, and function in the role of an advertiser or data consumer or both. A Clinical Research Organization is retained by the Pharmaceutical manufacturer to perform a study. The CRO designates a data supply chain manager and invites a set of physicians or puts out a call to a specialty group of physicians to participate in a study of the effects of a new medication as data suppliers. The FDA as a data beneficiary reviews the initial set of one or a plurality of data collections protocols and the study design. A set of physicians signs on to the study as data suppliers and provides access to their resumes and prior data collection and contribution experience. Each physician is assigned a weight/value and price for his contributions as of the date of his registration. Each physician may review the one or a plurality of data collection protocols and offer additional questions to be inserted into the respective data collection protocol at designated points within the study cycle. Additions or changes to questions are vetted and rated by the CRO, by the Regulator, by the Pharmaceutical manufacturer, and by other physicians associated with the study. Questions that are added to the one or a plurality of data collection protocols are attributed to the physician who offered the additional question and payment for data collected through that question is assigned to the physician and an adjustment in the physician's fee schedule/weighting/rating is made.

A participating physician provides an optical code to patients who serve in the role of data suppliers while the study is in process or upon a decision by the data supply chain manager to release portions of the study to one or a plurality of members of the data supply chain assigned roles as data consumers or data beneficiaries. In this case the patients may be in dual roles of data suppliers and provisional data consumers, while the physicians are in dual roles as data suppliers and data consumers. The patients recruited into the study who will receive the medication will use the data supply chain to self-report observations. The patient uses the optical code to enroll into the study and begins to enter data into the one or a plurality of data collection protocols. As patients are examined by physicians or their surrogates, physicians also enter and/or vet observations. A physician (data supplier with vetting rights) reviews and vets or validates entries made by his patients and/or surrogates. The peer group of physicians may also review the data and offer peer ratings for data and observations entered into the one or a plurality of data collection protocols. The CRO study coordinator vets or validates entries made by the physician. The CRO study coordinator also draws down vetted entries and observations and uses statistical and visualization software and tools to display and organize the data into a series of reports for the FDA, for the Pharmaceutical manufacturer, and to transmit back to the participating physicians. The one or a plurality of data collection protocols may go through one or more cycles of revision or fine tuning for the next portion of the study. A subset of the report may be generated for patients to review if shifts in risk profiles are tagged or other information the pharmaceutical company or CRO or regulator or even the physician group determine would be helpful for patients to receive. The manager of the data supply chain is able to allocate these rights and roles and views or to delegate their assignment be automated through the organizational structure and hierarchy of the relationships of participants in the data supply chain.

Based upon the weights and rating assigned, all participants in the data supply chain may be paid for their contributions. Patients receive reviews of their contributions that go into their contributor rating status and physicians receive peer reviews as well as reviews from the CRO that go into their contributor rating status, the CRO submitted one or a plurality of data collection protocols and clinical study reports are rated by the regulatory agency and the participating physicians to adjust the CRO's rating/status, and the Pharmaceutical manufacturer may be assigned ratings based upon aggregated or rolled up data and additional data from other studies. If nurses or other providers are involved in examinations and data entry, they also can be rated and folded into the data collection process.

The primary advantage of the invention described herein is that one or a plurality of embodiments motivates, rewards, attributes and apportions participation of data suppliers and data consumers in a data supply chain as the data supply chain is iteratively improved through systems and methods made available to participants. Social networks, crowd sourcing, and pervasive computing work together to enable a new paradigm for what one might view as a “global brain” that leverages both individual contributions and swarm behavior. Further the invention described herein is designed to advance a free market for data where attribution and compensation for intellectual property is maintained and traceable.

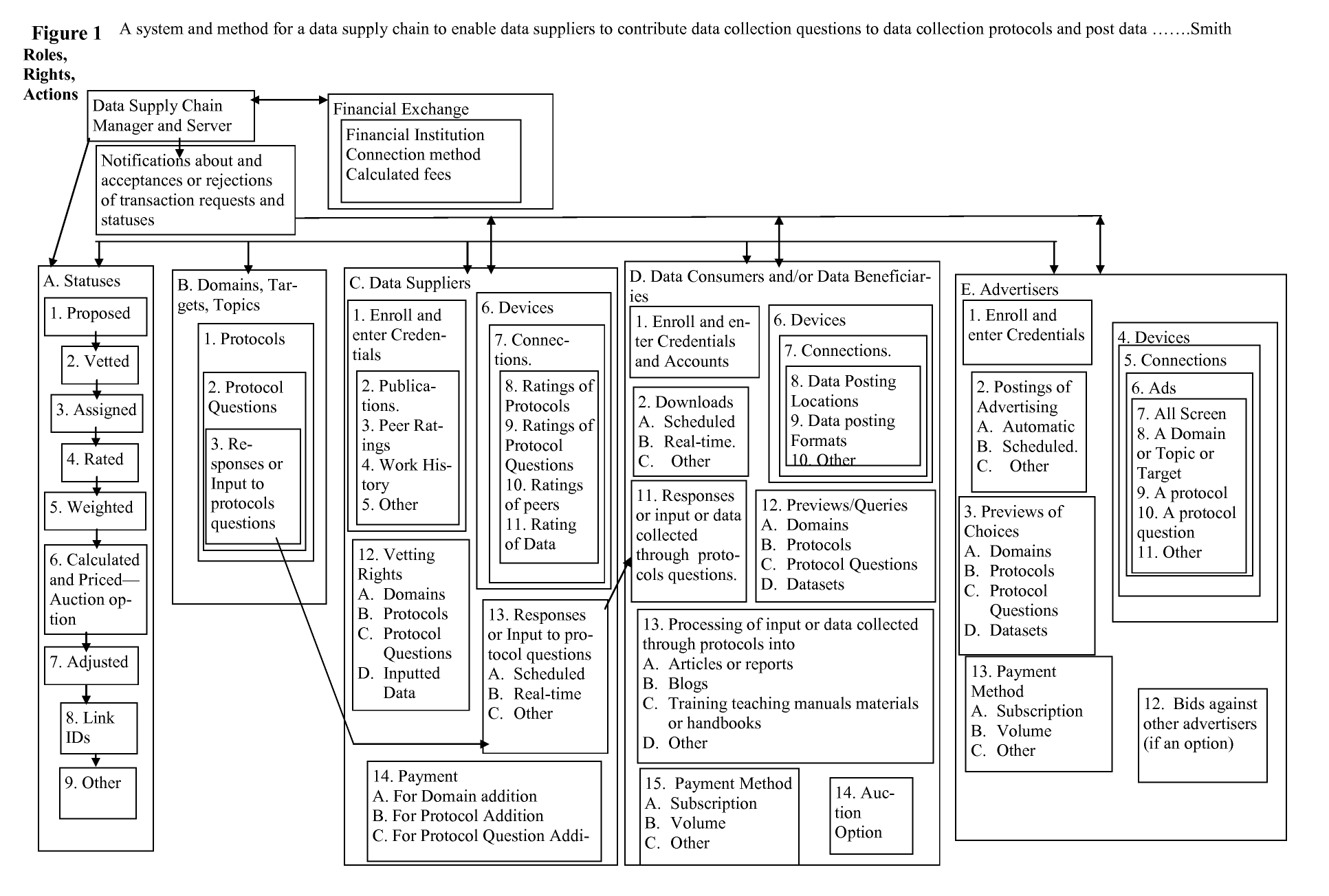

FIGS. 1, 2, and 3 represent how the system and method of the invention described herein is to be embodied. It is expected that many variations in embodiments will evolve, but the figures themselves are intended to represent the manner in which the claims for the invention described herein form a coherent and coordinated system and method. Redundancy of terms included in the figures is intentional because the complexity of the system requires the computer readable code that implements said system and method to address both structure and process. Natural language and terms for labels within said figures for processes and for components correlate directly with the language used in the claims and in the description of the invention described herein with every effort made to balance the need for parsimony in a figure against the need for clarity of attribution and meaning within a figure.

FIG. 1 frames how rights and roles and actions relate to one another. It begins with the Data Supply Chain Manager or a surrogate for the data supply chain manager determining the methods for financial exchanges and assigning statuses to roles and components of the invention described herein. Links across roles and statuses and domains along with the protocols assigned to the domains and the protocol questions within those protocols and the data input in response to those data questions are then linked to the data suppliers. As the data suppliers are enrolled and credentialed and the devices they use to connect to the data supply chains are enabled to authenticate as they are connected to the data supply chain, the vetting rights and process, the compensation parameters, and the contributions through the connection parameters are configured. Data supplier inputs and payments for inputs are also enabled and linked to the domains and back to the statuses and up to the data supply chain manager. Links are then made to the data consumer and parameters for connection and enrollment and credentialing are enabled for the data consumer. The data consumer is also configured according to payment options, data download methods and formats, data display, and other processing options, including participation in auctions and the final use of the data within articles or blogs and so forth. A further link from the Data Supply Chain Manager to the advertiser is defined and previewing, enrollment, bidding processes, payment methods and device connections are configured. Note also in the drawing (B3, C13, and D11) that responses and inputs are linked to domain, then supplied and entered, and then distributed. Note also that numbering sequences within boxes are sequential, but alternative sequences to the numbering can be readily embodied according to variations of the computer readable code to implement the system and method of the invention.

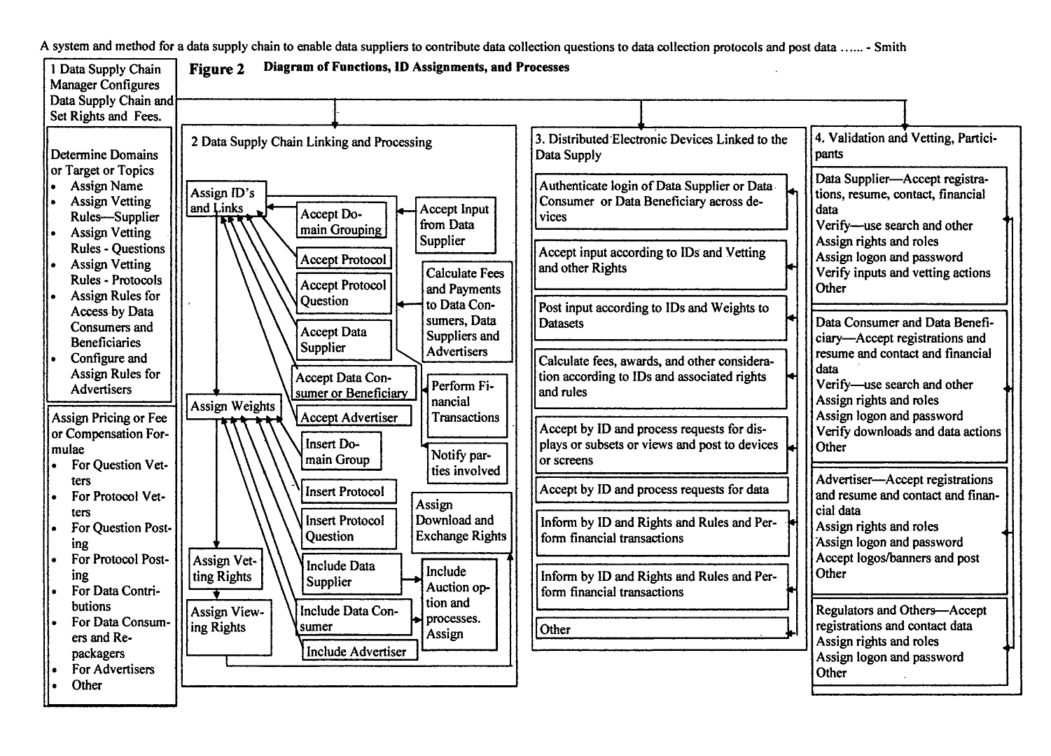

FIG. 2 explicates how the Data Supply Chain Manager or surrogates for the data supply chain manager link components of the system and method of the invention through specification of the components and assignment of the components within database structures through ID tags and processing instructions and computation alternatives. In FIG. 2, particular attention is paid to interaction and linking of rules and roles and devices in accordance with the procedures and functions described in the claims of the invention.

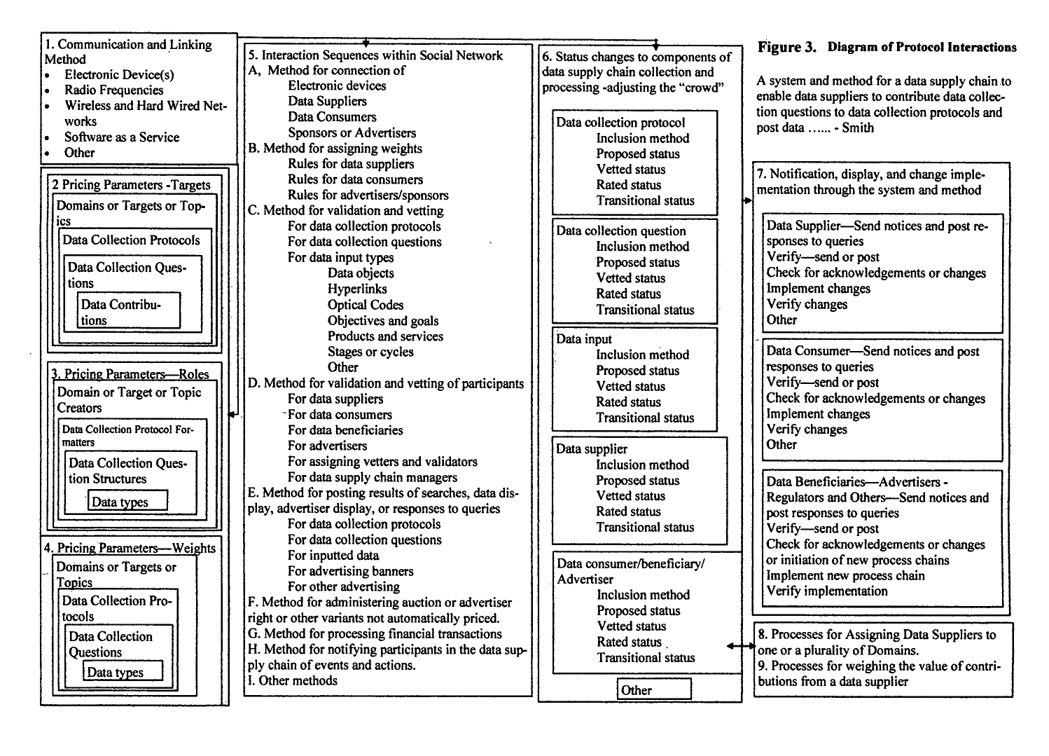

FIG. 3 explicates how the data collection protocol and the data collection questions themselves are fed into the systems and methods explicated in FIGS. 1 and 2 in order to distribute and provide access to participants in the data supply chain. In FIG. 3 social networks, the crowd, pervasive computing networks, and interactions across these from the data supply chain and the protocols that serve as the pivot for the data supply chain are mapped out according to multiple sub-methods or subroutines for distribution and assignment, weighting, display, and communication of notifications regarding activities, actions, and statuses within the data supply chain.

What is claimed is:

1. A marketing platform for a data supply chain for data suppliers and data consumers implemented through a system comprising one or a plurality of electronic devices capable of implementing computer readable code to operate as a server and including: a social network enabling crowd sourcing through one or a plurality of electronic devices accessible through one or a plurality of the Internet, wireless connections, and radio frequencies; one or a plurality of datasets distributed on the one or a plurality of electronic devices accessible to the crowd-sourced social network, each dataset housing one or a plurality of data collection protocols browse able on one or a plurality of electronic devices capable of functioning as a server and capable of implementing computer readable instructions to push and pull data for real time collection and real time distribution of data associated with said data collection protocols; collection, assignment, vetting, weighting and distributing of data collection questions offered by one or a plurality of data suppliers associated with one or a plurality of data collection protocols; collection, assignment, vetting, weighting and distributing of data collection protocols containing one or a plurality of data collection questions related to one or a plurality of knowledge domains or targets or topics of data collection; assigning a price, subscription value, access fee, contribution fee, viewing charge, or download price to one or a plurality of said data collection questions; assigning a price, subscription value, access fee, contribution fee, viewing charge, or download price to one or a plurality of said data collection protocols for collecting or entering or forwarding or trading data in real time; and assigning a price, fee, or charge to a manufacturer or service provider for associating advertising content and/or links through one or a plurality of data collections questions, one or a plurality of data collection protocols, one or a plurality of domains or targets or topics associated with said data protocols, or associating advertising content with data displayed or distributed to one or a plurality of participants in the marketing platform.

2. The system of claim 1, wherein a data collection protocol may be assigned a status of proposed prior to being vetted or validated; wherein a data collection question associated with one or a plurality of data collection protocols may be assigned a status of proposed prior to being vetted or validated; wherein a response to said data collection question may be assigned a status of proposed prior to being vetted or validated; and wherein a data collection protocol or a data collection question or input from one or a plurality of data suppliers may be assigned a status of automatically validated.

3. The system of claim 1, wherein the manager of the data supply chain may designate one or a plurality of data suppliers as having the right or role of a vetter for a domain or topic or target of one or a plurality of data collection protocols to change the status of a data collection protocol or a data collection question, or a response to a data collection question respectively from the status of proposed to validated; wherein the manager of the data supply chain may set a calculation rule for the number of designated vetters proposing a change from proposed to vetted for a data collection protocol, a data collection question, or a response or input into a data collection question to be implemented and assigned and stored as vetted or validated.

4. The system of claim 1, wherein the manager of the data supply chain may configure or instruct a data collection protocol to accept input of data or responses to vetted and validated data collection questions from one or a plurality of data suppliers included into the crowd-sourced social network and associated with one or a plurality of domains or targets or topics within a data supply chain; wherein one or a plurality of data suppliers may be an electronic device capable of generating computer readable code for posting data or computer readable strings of alphanumeric characters into the data supply chain; wherein one or a plurality of data suppliers may be a query or search engine capable of organizing data into tables or other formats readable through computer readable code for posting data into the data supply chain; wherein one or a plurality of data suppliers may be senders of radio signals that are capable of conversion into electronic signals readable by an electronic device capable of processing computer readable code for posting into the data supply chain; and wherein one or a plurality of data suppliers may be electronic devices such as a glucose monitor or other electronic device capable of generating data or strings of alphanumeric characters that can be converted into computer readable code to post said data as a response to a designated data collection question assigned to said data collection protocol.

5. The system of claim 1, wherein one or a plurality of electronic devices executes computer readable instructions to sort and organize said data collection protocols into one or a plurality of vetted and validated data collection protocols, one or a plurality of to-be-vetted proposed data collection protocols, and one or a plurality of datasets collected through entries of observations into vetted and validated data collection protocols.

6. The system of claim 3, wherein one or a plurality of electronic devices executes computer readable code to accept ratings or approvals of the one or a plurality of data collection questions or the one or a plurality of data collection protocols from one or a plurality of data suppliers assigned vetting rights for said unvetted or unvalidated data collection questions or said unvetted or unvalidated data collection protocols; calculates a score using statistical or mathematical methods determined by the manager of the data supply chain; and adjusts the status of the one or a plurality of data collection questions or the one or a plurality of data collection protocols according to whether a threshold value for a change of status from unvetted or unvalidated to vetted or validated is achieved.

7. The system of claim 3, wherein one or a plurality of electronic devices executes computer readable instructions to designate data associated with one or a plurality of datasets collected through entries of observations into one or a plurality of data collection protocols as automatically validated.

8. The system of claim 5, wherein one or a plurality of electronic devices executes computer readable code to organize and display the one or a plurality of data collection protocols or the one or a plurality of datasets collected through entries of data or one or a plurality of observations into vetted and validated data collection protocols to one or a plurality of data suppliers or one or a plurality of data consumers or to one or a plurality of data beneficiaries using one or a plurality of display formats grouped according to the one or a plurality of knowledge domains or targets or topics of said data collection protocols or data associated with said data collection protocols.

9. The system of claim 4, wherein the data offered by the data supplier in response to a data collection question within a data collection protocol is in one or a plurality of alternative formats assigned by the manager of the data supply chain to the data collection protocol; such as in the format of one or a plurality of advisory or coaching or counseling statements; or in the format of a milestone tag or percentage of project completion tag or description or label; or in the format of an inventory or product label tag or description or label.

10. The system of claim 1, wherein data can be in alternate formats of one or a plurality of alphanumeric characters, one or a plurality of hyperlinks, one or a plurality of encryption formats or keys, or one or a plurality of database objects.

11. The system of claim 1, wherein a list of available data collection protocols is accessed and posted upon one or a plurality of electronic devices capable of executing computer readable code in response to a query from a data supplier or data consumer or data beneficiary, the list of data collection protocols sorted according to criteria entered by the manager of the data supply chain or by delegation by the manager of the data supply chain of the right to set said criteria to the one or a plurality of data suppliers or the one or a plurality of data consumers or the one or a plurality of data beneficiaries.

12. The system of claim 11, wherein data accumulated into a list of available data collection protocols is posted upon one or a plurality of electronic devices capable of executing computer readable code in response to a request from a data supplier or data consumer or a data beneficiary, the list of data collection protocols sorted according to criteria entered by the manager of the data supply chain or by delegation by the manager of the data supply chain of the right to set said criteria to the one or a plurality of data suppliers or the one or a plurality of data consumers or the one or a plurality of data beneficiaries.

13. The system of claim 11, wherein validated and vetted data is selected for purchase by a data consumer on a subscription basis, said subscription providing the data consumer access to one or a plurality of datasets associated with one or a plurality of knowledge domains or targets or topics for a specified period of time at a specified price; or wherein validated and vetted data is selected for purchase by a data consumer for access to one or a plurality of datasets associated with one or a plurality of knowledge domains or targets or topics on a single pay-per-view or pay-per-download basis.

14. The system of claim 11, wherein validated and vetted data is offered through an auction to a subset of data consumers for access to one or a plurality of datasets associated with one or a plurality of knowledge domains or targets or topics.

15. The system of claim 1, wherein one or a plurality of electronic devices capable of implementing computer readable code executes programmable control logic to enable searching and retrieval of results related to data collection protocols accessible to the one or a plurality of said electronic devices in real time; and wherein said one or a plurality of electronic devices executes programmable control logic to distribute said results in real time or distributes said results through scheduled postings onto one or a plurality of other electronic devices to post said results into one or a plurality of databases.

16. The system of claim 1, wherein the system is further operative to display previews of one or a plurality of data collection protocols, previews of one or a plurality of datasets associated with the one or a plurality of data collection protocols, said data collection protocols or datasets residing on one or a plurality of electronic devices capable of implementing computer readable code accessible via one or a plurality of social networks enabled through the Internet or one or a plurality of other pervasive computing technologies to retrieve one or a plurality of data collection protocols and their associated one or a plurality of datasets through application programming interfaces.

17. The system of claim 1, wherein one or a plurality of data suppliers authorized to upload one or a plurality of data collection protocols may propose data collection questions for insertion into said data collection protocols to be vetted by a set of peer data suppliers; wherein an iterative sequence of said set of peer data suppliers may enter vetting responses, said vetting responses subjected to calculation to determine achievement of threshold values for inclusion into the data supply chain by the data supply chain manager or a surrogate of the data supply chain manager.

18. The system of claim 1, wherein one or a plurality of data suppliers authorized to upload one or a plurality of data collection protocols may append vetted data collection questions into said data collection protocols, or enter or contribute data or observations into said data collection protocols.

19. The system of claim 1, wherein one or a plurality of data suppliers may be charged a fee to include one or a plurality of data collection protocols developed by said one or a plurality of data suppliers into said data supply chain.

20. The system of claim 1, wherein one or a plurality of data suppliers may be charged a fee to include one or a plurality of data collection questions developed by said one or a plurality of data suppliers into one or a plurality of data collection protocols included in the data supply chain.

21. The system of claim 1, wherein one or a plurality of electronic devices can execute computer readable code to process an online payment to or from a data supplier or receive payment from a data consumer; or wherein said electronic devices can process and post awards or recognition statuses or messages into social networks associated with the data supply chain as a substitute or compliment to a monetary payment.

22. The system of claim 1, wherein a data consumer or a data beneficiary may enter one or a plurality of quality or value ratings for the one or a plurality of data collection protocols or the data associated with the one or a plurality of data collection protocols.

23. The system of claim 1, wherein one or a plurality of data collection protocol data previews includes posting or displaying upon an electronic device one or a plurality of quality or value ratings collected from one or a plurality of data consumers who purchased access to the data collection protocol or the dataset associated with the data collection protocol.

24. The system, of claim 1, wherein the one or a plurality of data collection protocols are accessible to data suppliers or to data beneficiaries who have been qualified based on one or a plurality of credentials or ratings collected from members of the social network associated with the knowledge domain or target or topic of said data collection protocol.

25. The system of claim 24, wherein said credentials may one or a plurality of demographic or historical Biodata associated with the data supplier, such as regulatory roles and assignments, education, work history, publications, awards, professional association memberships, and ratings received from members of social networks for prior contributions of formats for data collection protocols, data collection questions, or for posting data into data collection protocols.

26. The system of claim 1, wherein data collection protocols and data collection questions are subjected to vetting prior to inclusion into the data collection and distribution platform.

27. The system of claim 1, wherein the system is further operative to convert data uploaded by an authorized data supplier into formats for viewing by data consumers regardless of the computer readable code used to enter the data.

28. The system of claim 16, further comprising receiving a browse or search request from a data supplier or a data consumer, retrieving a plurality of previews of one or a plurality of data collection protocols from one or a plurality of electronic devices capable of implementing computer readable code responsive to the browse or search request, and displaying the previews upon the one or a plurality of display screens associated with the one or a plurality of electronic devices.

29. The system of claim 1, further comprising receipt of a query from a data supplier; displaying the query to one or a plurality of data suppliers associated with the knowledge domain or target or topic of the data collection protocol; receiving a prospective phrasing of one or a plurality of data collection questions to be appended to or proposed for inclusion into one or a plurality of existing data collection protocols from the one or a plurality of data suppliers associated with the knowledge domain or target or topic of the data collection protocol; and transmitting the prospective questions to the network or crowd of data suppliers or data beneficiaries associated with the domain or target or topic of the data collection for vetting and scoring or weighting to formulate a list of ranked or rated questions proposed for inclusion into the one or a plurality of data collection protocols.

30. The system of claim 1, further comprising assigning a unique question ID to one or a plurality of questions included into one or a plurality of data collection protocols.

31. The system of claim 1, further comprising associating the domain or target or topic of the data collection question with the question ID, and displaying one or a plurality of existing data collection questions associated with the domain or target or topic of the question to accept input regarding adjustment for wording or phrasing or weighting or scoring or ranking of the one or a plurality of existing data collection questions.

32. The system of claim 1, further comprising assigning a unique data supplier ID or data beneficiary ID to a question from a data supplier included into one or a plurality of data collection protocols.

33. The system of claim 1, further comprising associating the domain or target or topic of a data collection question with the data supplier ID, and displaying one or a plurality of existing data collection protocols and questions associated with the domain or target or topic of the question to accept input regarding adjustment for weighting or scoring or ranking of the one or a plurality of data suppliers.

34. The system of claim 1, further comprising associating the domain or target or topic of a data collection question with a data consumer ID or a data beneficiary ID, and displaying one or a plurality of existing data collection protocols and questions associated with the domain or target or topic of said data collection question.

35. The system of claim 1, further comprising assigning a unique data collection protocol ID to a question assigned to a data collection protocol.

36. The system of claim 1, further comprising assigning a unique advertiser ID to a question assigned to a data collection protocol.

37. The system of claim 1, further comprising assigning a unique advertiser ID to a data collection protocol.

38. The system of claim 1, further comprising assigning a unique advertiser ID associated with a domain or topic or target of a set of data collection protocol.

39. The system of claim 1, further comprising associating the domain or target or topic of a data collection question with a data collection protocol ID, displaying one or a plurality of data collection protocols associated with said domain or target or topic to accept input regarding adjustment for weighting or scoring or ranking of the one or a plurality of data collection protocols, one or a plurality of data collection questions associated with said data collection protocols, and one or a plurality of data suppliers approved to contribute data into said data collection protocols for posting into a display viewable by a data consumer; to calculate said input and post adjusted weighting or scoring or ranking of the one or a plurality of data collection protocols, one or a plurality of data collection questions, and one or a plurality of data suppliers; wherein the system enables one or a plurality of data consumers to browse said weighting or scoring or ranking of said data collection protocols, data collection questions, and said data suppliers; and to elect to purchase rights to download or subscribe to said data for processing or viewing on a local electronic device or through accessing a web portal, or a software as a service access point, or a social network.

40. The system of claim 39, wherein one or a plurality of the data collection protocols undergo a quality content review and receive a vetted status and some one or a plurality of the data collection protocols are assigned a non-vetted status.

41. The system of claim 39, wherein an internet search is conducted of public sources to collect data regarding the one or a plurality data suppliers including of the one or a plurality of educational degrees obtained by the data supplier, the one or a plurality of job titles held by the data supplier, the one or a plurality of publications by the data supplier with associated ratings for the prestige of the journal, publication, publisher, or venue of the article, the one or a plurality of awards given to the data supplier with associated ratings for the prestige or the award within the academic discipline of the data supplier, the one or a plurality of reviews of publications associated with the data supplier, and the one or a plurality of peer reviews of a data supplier; creating a rank ordered list of the data supplier's expertise by applying a cumulative calculation or probabilistic analysis on the search results, clustering said list into a plurality of categories based on said correlations, presenting said list to said data supplier for confirmation and prioritization; and inserting the confirmed list into a data supplier's profile.

42. The system of claim 39, wherein a data supplier profile is mapped and correlated and assigned to one or a plurality of data collection protocols.

43. The system of claim 39, wherein one or a plurality of data suppliers assigned to a data collection protocol can rank or score or rate the profile of the one or a plurality of other data suppliers assigned to said data collection protocol to generate a cumulative ranking of data suppliers to be displayed to data consumers and to be used to proportionate calculation of fees and prices for data collection observations and entries into said data collection protocol.

44. The system of claim 39, wherein one or a plurality of data consumers assigned access to a data collection protocol are able to rank or score or rate the relative value of a data collection protocol to generate a cumulative ranking of data collection protocols grouped according to knowledge domain or target or topic to be displayed to data consumers and to be used to proportionate calculation of fees and prices for observations and entries into said data collection protocol.

45. The system of claim 39, wherein one or a plurality of data consumers assigned access to a data collection protocol are able to rank or score or rate the data purchased through subscription or pay-per-view or pay-per-download to generate a cumulative ranking of data associated with data collection protocols grouped according to the knowledge domain or target or topic to be displayed to data consumers and to be used to proportionate calculation of fees and prices for data extracted by the data consumer from data associated with a data collection protocol.

46. The system of claim 39, further comprising receiving an image of a coding symbol readable by an optical reading device sent from an electronic device or a mobile communication device accessible to a prospective or a vetted data supplier, the code image derived from a scan of said coding symbol; converting said image of a coding symbol into an alphanumeric string; querying the data on one or a plurality of electronic devices to discern a data collection protocol identifier corresponding to characters contained with said alphanumeric string; retrieving a data collection protocol from data collection protocols distributed upon the one or a plurality of electronic devices that matches the data collection protocol identifier; sending a sample of the questions contained within the data collection protocol to the electronic device or the mobile communications device via a communications network or the Internet; receiving an acceptance message from the data supplier; linking the data supplier to the data collection protocol provided that the acceptance message indicates that the data supplier wishes to contribute data into the data collection protocol; and storing a record of the alphanumeric string in association with the data supplier.

47. The system of claim 39, further comprising receiving an image of a coding symbol readable by an optical reading device sent from an electronic device or a mobile communications device by a prospective data consumer, the code image derived from a scan of said coding symbol; converting said image of a coding symbol into an alphanumeric string; querying a database to discern a data collection protocol identifier corresponding to the alphanumeric string; retrieving a data collection protocol from the set of data collection protocols based upon the data collection protocol identifier; sending a sample of the questions contained within the data collection protocol to the mobile communications device via a communications network; receiving an acceptance message from the data consumer; linking the data consumer to the data collection protocol provided that the acceptance message indicates that the data consumer wishes to purchase data associated with the data collection protocol; and storing a record of the alphanumeric string in association with the data consumer.

48. The system of claim 39, further comprising notification of the data consumer of a single or a plurality of fees for access to at least one or a plurality of views or downloads of at least one or a plurality of data fields or observations drawn from the accumulated data associated with said data collection protocol.

49. The system of claim 39, further comprising notification of one or a plurality of data suppliers of a payment for their apportioned weighted ranked cumulative contributions of observations to said data collection protocol.

50. The system of claim 39, further comprising notification of one or a plurality of data suppliers the completed payment transaction for their apportioned weighted ranked cumulative contributions of observations to said data collection protocol.

51. The system of claim 39, further comprising processing a payment from the data consumer of a fee for access to at least one or a plurality of views or downloads of at least one or a plurality of data fields or observations drawn from the accumulated data associated with said data collection protocol.

52. The system of claim 39, further comprising notification of the data consumer of the completed payment transaction for at least one or a plurality of views or downloads of at least one or a plurality of data fields or observations drawn from the accumulated data associated with said data collection protocol.

53. The system of claim 39, further comprising posting fees or prices for association or linking of one or a plurality of data collection protocols with one or a plurality of manufacturers or providers of materials or services identified through one or a plurality of brands, domains, topics, or lists drawn from identifiers of one or a plurality of data suppliers or consumers.

54. The system of claim 39, further comprising posting fees or prices for association or linking of one or a plurality of data collection protocols with one or a plurality of manufacturers or providers of materials or services identified through one or a plurality of brands, domains, topics, or lists drawn from one or a plurality of words or phrases in one or a plurality of data collection protocols.

55. The system of claim 39, further comprising acceptance of an association request from a manufacturer or provider of materials or services.

56. The system of claim 39, further comprising notification of acceptance to the manufacturer or provider of materials or services identified in said one or a plurality of data collection protocols.

57. The system of claim 39, further comprising processing a payment from said accepted manufacturer or provider of materials or service associated with one or a plurality of data collection protocols; and assigning.

58. The system of claim 39, further comprising notification of said accepted manufacturer or provider of materials or service associated with one or a plurality of data collection protocols of the completed payment transaction for at least one or a plurality of listings or display of one or a plurality of advertising banners viewable to data consumers or data suppliers upon display screens of electronic devices associated with said data collection protocols.

59. The system of claim 39, further comprising assigning an ID to said accepted manufacturer or provider of materials or service associated with one or a plurality of data collection protocols and associating said assigned ID with the ID of the associated data collection protocol.

59. The system of claim 39, further comprising the manager of the data supply chain designating a subset of the data supply chain to be auctioned through one or a plurality of online auction venues or methods.

60. The system of claim 39, further comprising assigning an auction participation ID to one or a plurality of data consumers upon a request by said one or a plurality of data consumers to participate in an auction associated with a subset of data collected through the data supply chain.

61. The system of claim 39, further comprising notification of one or a plurality of data consumers of the strike price offered by the highest bidder upon completion of an online auction process for a subset of the data collected through the data supply chain and offered through said auction process.

62. The system of claim 39, further comprising processing a payment from said highest bidder for a subset of the data collected through the data supply chain and offered through said auction process.
